(19) United States
(12) Patent Application Publication
(10) Pub. No.: US 2013/0287361 A1
(43) Pub. Date: Oct. 31, 2013

(54) METHODS FOR STORAGE AND ACCESS OF VIDEO DATA WHILE RECORDING

(71) Applicant: MOG Technologies S.A., (US)

(72) Inventor: Vitor Teixeira, Moreira da Maila (PT)

(73) Assignee: MOG TECHNOLOGIES S.A., Moreira da Maila (PT)

(21) Appl. No.: 13/662,556

(22) Filed: Oct. 29, 2012

Related U.S. Application Data
(60) Provisional application No. 61/594,254, filed on Feb. 2, 2012.

(51) Int. Cl. H04N 9/79

(52) U.S. Cl. CPC H04N 9/79
USPC 386/224; 386/328

(57) ABSTRACT

The present invention provides, in at least one embodiment, a video data recorder system and method that allows video data that is continually being recorded, to be stored into storage with a constant bytes per edit unit group, accessed, previewed, and edited by a user interface. The video data can be stored, accessed, previewed, and edited on the fly, that is, while the video is simultaneously recording before it has finished with minimum overhead and deterministic re-synchronization in the recorded file when being accessed thus simplifying and enhancing the decoder performance.

### CROSS REFERENCE TO RELATED APPLICATIONS

This application claims priority under 35 U.S.C. §119(e) to U.S. Provisional Application No. 61/594,254, filed Feb. 2, 2012, and entitled “METHODS FOR STORAGE AND ACCESS OF VIDEO DATA WHILE RECORDING,” the disclosure of which is hereby incorporated by reference in its entirety.

### BACKGROUND OF THE INVENTION

1. Field of Invention

The invention relates generally to multimedia (or “media,” e.g., video and audio) recording and more particularly to techniques for storing, writing a file format layout, decoding, and accessing video and audio data in a multimedia file while the multimedia file is being created, i.e., as the video and audio are recorded.

2. Description of Related Art

A digital video recorder is generally any electronics device or application software that records video in a digital format to a storage medium such as, but not limited to a disk drive, USB flash drive, memory card or other local or networked mass storage device. The video recorder enables video capture and playback to and from the digital storage. One of ordinary skill in the art readily appreciates that the term “video” may include audio data, e.g., an audio track, in addition to images. Digital video comprises a series of orthogonal bitmap digital images displayed in rapid succession at a variable rate and typically at a constant rate as well. These images are called frames and the rate at which frames are displayed is measured as frames per second (FPS).

Video compression or video coding is the process of compressing (encoding) and decompressing (decoding) video. Digital video takes up a very large amount of storage space or bandwidth in its original, uncompressed form. Video compression makes it possible to send or store digital video in a smaller, compressed form. Source video is compressed or encoded via an encoder before transmission or storage. Compressed video is decompressed or decoded via a decoder before displaying it to the end user. Compression is useful because it helps reduce the consumption of expensive resources, such as hard disk space and transmission bandwidth. The design of data compression schemes involves trade-offs among various factors, including the degree of compression, the amount of distortion introduced, and the computational resources required to compress and decompress the data. The Moving Picture Experts Group (MPEG) sets standards for audio and video compression and transmission. MPEG standards come in many versions (e.g., MPEG-1, MPEG-2, MPEG-4, MPEG-7, MPEG-21), the identification and implementation of which is apparent to one of ordinary skill in the art, and exist to promote system interoperability among computers, televisions, and video and audio devices.

Digital data buffers are often implemented to temporarily hold video and audio data while it is being processed or transmitted over a network. Buffers are typically used when there is a difference between the rate at which data is received and the rate at which it can be processed. A buffer often adjusts the timing by implementing a queue algorithm in memory, simultaneously writing data into the queue at one rate and reading the data at another rate. When media is streamed over a network, the decoder receives encoded data at a theoretically constant rate (the transmission rate). The decoder consumes this data to produce decoded output. Sometimes, however, the decoder consumes the data at a variable rate because the encoder implements a variable encoding rate.

The “leaky bucket” model is a way to model the buffering requirements for smooth media playback. In this model, the decoder maintains a buffer. Encoded data goes from the network into the buffer, and from the buffer into the decoder. If the buffer underflows, it means the decoder is removing data from the buffer faster than the network is delivering it. If the buffer overflows, it means the network is deliver data faster than the decoder consumes it. The goal of an encoder is to ensure that the content never overflows the buffer. The encoder uses the bit rate and buffer window values as guides. The actual number of bits passed over any period of time equal to the buffer window can never be greater than twice the size of the buffer.

An MPEG encoder employs a video buffering verifier (VBV). The video buffer verifier is used to ensure that an encoded video stream can be correctly buffered and played back at the decoder device. The video buffer verifier receives frames of different sizes, and the video buffer verifier's goal is to prevent underflow and overflow of the buffer, e.g., using the leaky bucket model. There are two operational modes of video buffer verifier: constant bit-rate (CBR) and variable bit-rate (VBR). In constant bit rate, the decoder's buffer is filled over time at a constant data rate. Conversely, in variable bit-rate, the decoder's buffer is filled at a variable rate. In both cases, data is removed from the buffer in varying chunks, depending on the actual size of the coded frames. The buffer limits must be respected, including keeping the buffer between its minimum and the maximum bitrate.

The Material Exchange Format (MXF) standard, specified by the Society of Motion Picture and Television Engineers, defines edit units (frames) as: constant bytes per element (CBE) and variable bytes per element (VBE). Typically, one element contains one frame, although one element can just be part of one frame or can include several frames. A constant bytes per element stream is a set of pictures all with the same size. On the decoder side, a constant bytes per element stream is easier to handle since it reduces the indexing and partitioning complexity thus allowing a simpler way to access a stream while it is being generated and transmitted.

Conventionally, constant bytes per element and variable bytes per element have different file layouts. Further, they each have different file layouts depending on whether the file is open or closed. An open file is a file that is still being written, whereas a closed file is complete. The conventional file layouts include generic containers. The file layouts may also include one or more headers, body or footer partitions, header metadata, and index tables.

The conventional process for opening and seeking in a file or stream that is being generated includes two steps: gathering information and seeking within the stream. First, gathering information can include determining the structure of the group of pictures and pre-charge information including frames to be decoded but not displayed. Gathering information can also include determining the body offset, which is the byte position from the start of the generic container and the first byte of the video essence. The information can be gathered from header metadata and index tables in a material exchange format file.

Second, for seeking within a stream that includes locating and syncing to the key-length-value (KLV). The key-length-value is a data encoding standard used to embed information in video feeds. Items are encoded into key-length-value triplets, where the key identifies the data, the length specifies the data's length, and the value is the data itself. Key-length-value is defined by the Society of Motion Picture and Television Engineers in SMPTE ST 336:2007. This syncing process can include indexing any information that exists and determining the body offset, where partition headers must be discarded while seeking the body offset, according to material exchange format standards. The process may also include doing a byte scanning or weight bet on the bitrate depending on whether the buffer is in constant bit-rate or variable bit-rate mode.

Conventional encoding, for example, to generate a material exchange format with long group of picture video of constant bit-rate essence, can be performed in one of the following ways. One option for encoding is to generate index tables after encoding and storing the essence, thus buffering the index tables until the next body partition is to be stored. This complicates the buffering requirements. Another option for encoding is to save the index tables before the essence. This can be accomplished by buffering images and generating the index tables before serializing the essence, causing even more buffering complications than the previous option. An alternative for this option can be accomplished by reserving indexing space, saving the video and audio data, and seeking back in a seekable medium to write the data. A further option for encoding is to save the index tables into a separate file referred to as a reference file. Creating multiple files creates complications, since each file must be accessed to encode the data.

For decoding the above encoded data, the decoders must perform synchronization. To accomplish that requires either reading the material exchange format header and multiple index table segments, or reading the reference file from a separate file independent of the file containing the essence. For reading the material exchange format header and index tables, this must occur after the body partition in the first encoding option and prior to each body partition in the second encoding option discussed above. When the material exchange format header and index tables are read after the body partition, the material exchange format index information is only available after the full video data on the partition is fully written. Alternatively, to read the reference file from a separate file requires managing several files. Managing several files having multiple index tables and body partitions leads to complexity at the decoder level.

U.S. Pat. No. 7,717,609 issued to Lim, the disclosure of which is herein incorporated by reference in its entirety, is directed to digital video recording apparatus and editing method for recorded broadcast programs. Information of recorded broadcast programs is extracted from a broadcast stream which includes the broadcast programs. The extracted information is displayed on a display in the form of a program record list. Accordingly, the user can easily edit recorded broadcast programs by simply editing the program record list.

However, these and other conventional devices fall short, because they lack, a simple structure and method for writing a file format layout that allows decoders to rapidly seek to any point of the file in a deterministic way or stream and open or edit a file that may still be growing.

### SUMMARY OF THE INVENTION

The present invention provides a video data recorder system and method that allows video data that is continually being recorded, to be stored into storage with a constant bytes per edit unit group, accessed, previewed, and edited by a user interface. The video data can be stored, accessed, previewed, and edited on the fly, that is, while the video is simultaneously recording before it has finished with minimum overhead and deterministic re-synchronization in the recorded file when being accessed thus simplifying and enhancing the decoder performance.

An advantage of the present invention is that it eliminates the need to do byte scanning and partition synchronization. Further, the invention produces a smaller overhead, little to no routing information protocol (RIP), minimal file partition complexity, simple indexing, and little to no latency. The method allows for deterministic re-synchronization, an easier way determine seek positions and compute body offsets, and a very simple file decoding in progressive download applications, play while recording, and closed files. Deterministic re-synchronization, as opposed to byte scanning and KLV jumping, minimizes the interaction with the video file stored in the storage in the reading and seeking byte methods leading to a minimum seek time.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, and the advantages thereof, reference is now made to the ensuing descriptions taken in connection with the accompanying drawings briefly described as follows:

FIG. 1 illustrates a recorder system according to an embodiment of the invention;

FIGS. 2-3 illustrate file layouts of video data according to embodiments of the invention;

FIGS. 4-7 illustrate essence containers of the file layouts according to embodiments of the invention; and

FIG. 8 illustrates a process of accessing video data while recording according to an embodiment of the invention.

### DETAILED DESCRIPTION OF EMBODIMENTS

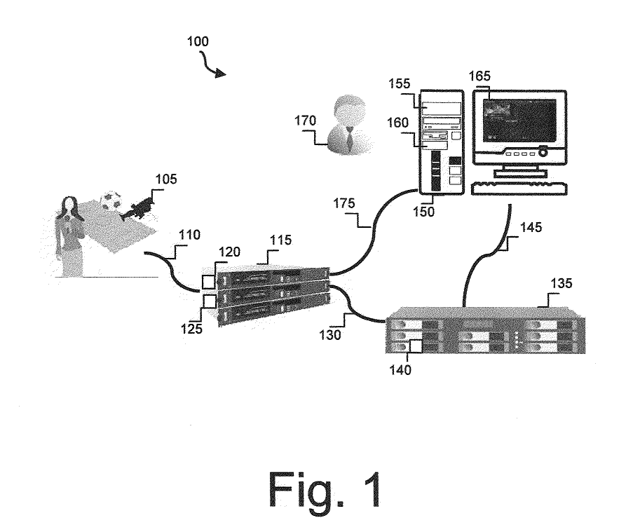

Further features and advantages of the invention, as well as the structure and operation of various embodiments of the invention, are described in detail below with reference to the accompanying FIGS. 1-8, wherein like reference numerals refer to like elements. Although the invention is described at times in material exchange format (MXF), as specified by Society of Motion Picture and Television Engineers, the method can be performed in many other types of file formats including all major broadcast formats such as Avid, QuickTime, MPEG-1, MPEG-2, MPEG4, AVC, DVCPRO, XDCAM, JPEG2000, ProRes, etc. Further, although the invention is described with certain features (e.g., encoder, decoder, editor, etc.) located inside a particular device (e.g., a video camera, a recorder, a computer, etc.) one of ordinary skill in the art appreciates that these features are not limited to the illustrated device.

The method allows for storage and access of video and audio data while recording. Accessing the video while recording allows for “edit while capture.” Edit while capture allows recorded video clips to be worked right away in players and editors, even while the system is still recording.

The encoded video data may include encoded video such as long group of picture (GOP) Moving Picture Experts Group (MPEG). The encoded video data is formatted into a stream or file such as material exchange format (MXF). The method creates a file layout which achieves minimal overhead and complexity compared to conventional designs thus transparent for systems that are not aware of the embodiment enhancements. The method also simplifies the decoding of the video data to allow fast seeking with deterministic re-synchronization and positioning even while the file is being generated.

The method stores encoded video frames, pictures, or images formatted into a file or stream, and the video frames may contain variable byte sizes. The encoded video frames are stored in a way such that a multiple group of pictures have a constant number of bytes per a period unit simplifying the access, seek and decoding processes. The period unit shall be higher than a video frame period (e.g., 1 second, 2 seconds, 5 seconds, 10 seconds, etc.). The method can be performed in many types of file formats including material exchange format.

The method of the invention allows for recording the video stream allowing seek access even while the file is being recorded in a material exchange format container and with a deterministic positioning with no byte scanning The method that generates a simple operational pattern even in the case of VBE video essence. The operational pattern (e.g., wrappers) can include, for example, material exchange format OP-Atom, material exchange format OP1A, material exchange format OP1B, or QuickTime.

The proposed layout defines a group of frames (this value should be equal or higher than the GOP—Group-Of-Picture—referred in the MPEG nomenclature) with a fixed synchronization time period T (e.g., 1 second, 2 seconds, 5 seconds, etc.), such that the Group edit rate is 1/T. The synchronization period byte length, X, maps to the next temporal seeking position time period T within the essence container at the start of a video, audio, and data frames from (e.g., a key-length-value packet). The information of the byte size for each time period T shall be transmitted inbound or outbound in the encoded and format video file.

In this method, the seeking position must start with the beginning of a GOP, and preferably the GOP should be fixed. Further, metadata signals the start of play and may be higher than the first I-frame available in the pre-charge stream and will signal the duration of the playing stream or the end of the last playable frame. Remaining frames are then considered as non-playable post-charge.

FIG. 1 illustrates a recorder system 100 according to an embodiment of the invention. The system 100 includes a video camera 105 producing a video data signal 110, a recorder 115 having an encoder 120 and a controller 125, producing an encoded video data/file 130 to a storage 135 with storage units 140, that makes available a formatted and encoded video data/file(s) 145 to a computer 150 having a decoder 155, a processor 160, and a user interface 165 for a user 170 that controls the recorder 115 via a control interface 175 (e.g., RS422, HTTP, or SOAP). The system 100 allows the video data signal 110 that is continually being recorded as the encoded video data 130, to be stored into the storage 135 as encoded and formatted video files 145, and accessed, previewed and edited by the user interface 165. The system 100 can be used in many applications and productions, such as outside broadcast (OB) vans, live and remote productions, multicamera productions, news productions, studio recording, sports highlights, etc.

The video camera 105 (e.g., video recorder, video tape recorder, video signal generator, video signal source, etc.) includes one or multiple cameras that tape live feeds of the video data signal 110. The video data signal 110 includes audio frames, video frames, and data frames. The video camera 105 can film the video data signal 110 in standard definition (SD), high definition (HD) or higher video definitions. After the video data signal 110 has been encoded into the encoded video data 130 and formatted into the formatted and encoded video files 145, the video data signal 110 can be a video file, video stream, video clip, audio/video recording, file layout, etc.

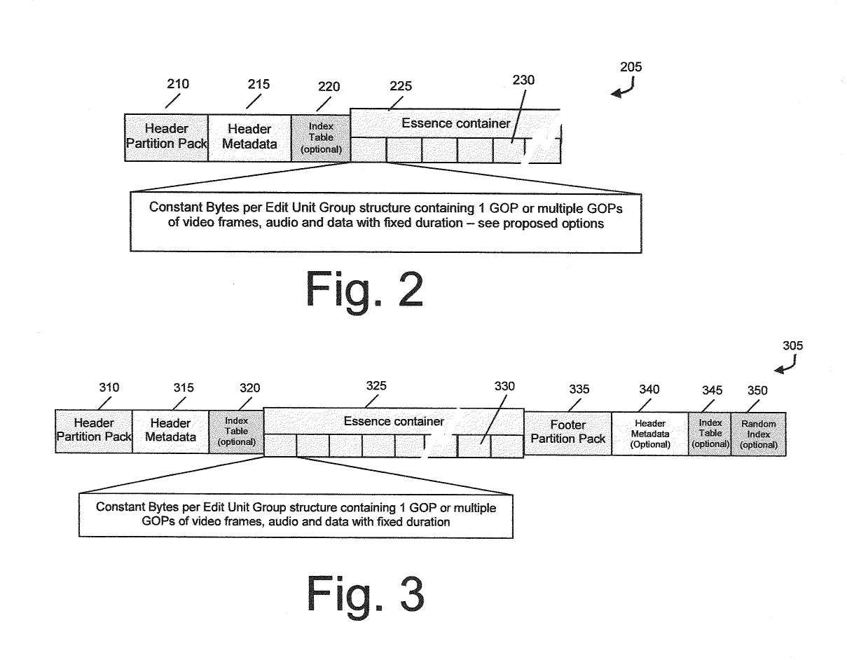

The recorder 115 can record the video data signal 110 from the video camera 105. The recorder 115 can have a serial digital interface for high quality recording. The recorder includes the encoder 120 and the controller 125. The encoder 120 creates the encoded video data 130 and the formatted and encoded video files 145 in a file layout that is easier to store, access, preview, and edit. The file layouts are discussed further with respect to FIGS. 2 and 3. The controller 125 receives the video data signal 110 from the video camera 105 and sends the encoded and formatted video files 145 to the storage 135.

The storage 135 makes the video files 145 available to the computer 150 that reads the formatted and encoded video files 145 to the decoder 155 using the processor 160. The decoder 155 includes a regular decoder and an enhanced decoder. The decoder 155 decodes the data to obtain the original video data signal 110 as it existed before being encoded by the encoder 120. The decoded video data signal 110 can go to the user interface 165. The processor 160 can be any computer processor configured to receive and present the decoded video data to the user 170. The storage 135 stores the encoded video data 130 and provides the formatted and encoded video files 145 to the computer 150. The storage 145 can be any type of storage, such as a shared media storage, memory, proxy storage, online storage, portable hard-disk, etc.

The user interface 165 (e.g., graphical user interface) can be any program for accessing, viewing, and/or editing the formatted and encoded video files 145 by the user 170. Accessing can also be referred to as opening, random access, decoding, reading the file, etc. The user interface 165 can open and edit the formatted and encoded video files while the recorder 115 is continually recording the encoded video data 130.

The user interface 165 can have a video monitor, video tape recorder (VTR) controller, gang control, record control, layout editor, and scheduler. The user interface 165 allows the user 170 to preview and edit the video while capturing the video. The video monitor displays the live recording. The controller 125, when connected to a video tape recorder, can include play, pause, rewind, fast forward, and seeking to control the video data signal 110 via the control interface 175 (RS422, HTTP or SOAP). The controller 125 can also make batch capture simple. The controller 125 can pause and stop the recording. The layout editor allows editing of the live broadcast. The scheduler allows capturing of a live feed at any time and date.

FIGS. 2-3 illustrate file layouts 205, 305 of the encoded video data 130 according to embodiments of the invention. FIG. 2 illustrates the file layout 205 of the encoded video data 130 that is being recorded, whereas FIG. 3 illustrates the file layout 305 of the encoded video file 130 that has finished recording. The formatted and encoded video files are then made available to the decoder 155.

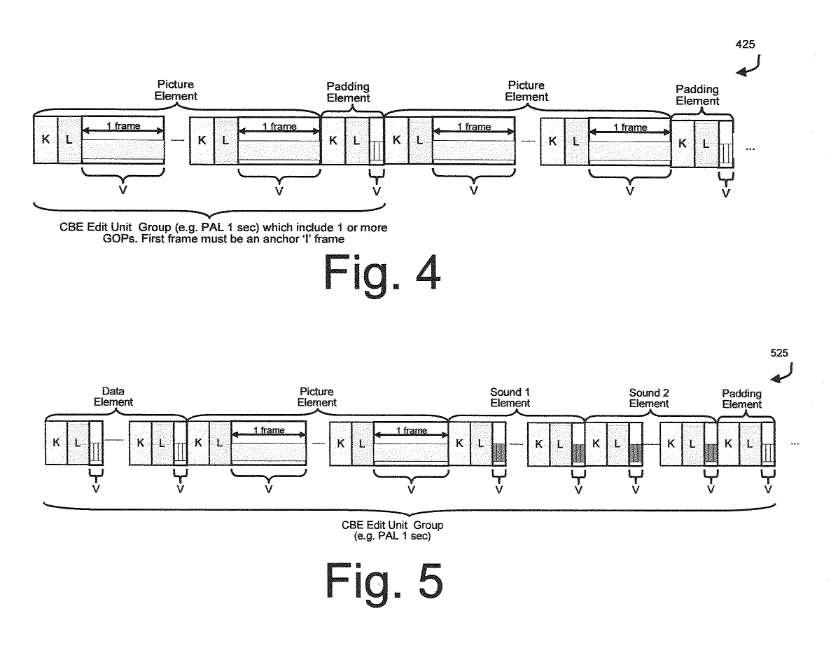

In FIG. 2, the encoded video file 130 is continually recording, meaning the video recording has not finished. The file layout 205 (e.g., simple file layout, layout without body partitions, etc.) includes a header partition pack 210, a header metadata 215, an optional index table 220, and an essence container 225 having at least one edit unit Group 230 (e.g., essence unit). Four embodiments for the essence container 225 are illustrated with respect to FIGS. 4-7.

Each edit unit Group 230 includes a constant number of bytes and can be referred to as a constant bytes per element group, CBE Group size, constant byte per edit unit Group structure, etc. The size of the bytes for each edit unit group can be calculated as: Byte offsets between KLV seek points packets=Bitrate*T+VBV buffer+overhead (e.g., material exchange format KL length for all elements in the container). The edit unit group is for limited constant bytes per element window size with the leaky bucket MPEG buffer mechanism. For MPEG video encoders and decoders, padding the transport layer (e.g., in material exchange format) is invisible to the encoders and decoders.

The edit unit Group 230 can represent one group of pictures (GOP), or can also represent multiple groups of pictures or a portion of one group of pictures. The edit unit group includes encoded video data with a fixed duration in time, T Group. Each content package edit unit group has the same size.

FIG. 3 illustrates the file layout 305 of the encoded video data that has finished recording. The encoded video data has completed recording and thus is a complete file. Similar to FIG. 2, the file layout 305 (e.g., simple file layout, layout without body partitions, etc.) includes a header partition pack 310, a header metadata 315, an optional index table 320, and an essence container 325 having at least one edit unit group 330 (e.g., essence unit). Since the file is complete, the file layout 305 includes a footer partition pack. Optionally, the file layout 305 can include an optional update metadata header 340, another optional index table 345, and an optional random index pack 350. Four embodiments for the essence container 325 are illustrated with respect to FIGS. 4-7.

FIGS. 4-7 illustrate essence containers 425, 525, 625, and 725 for the file layouts 205, 305 according to embodiments of the invention. FIGS. 4-7 illustrate the organization of each content package edit unit group with a fixed size (bytes), CBE Group, and fixed duration (seconds), T Group, for the key-length-value (KLV) framed wrapped essence. The number of fixed bytes and fixed duration will be included in the file Header Metadata 215 and 315 as dark metadata or using another outbound information mechanism. Each element group is wrapped contiguously until the next element kind to form a constant bytes per element. The constant bytes per element, T Group, may be, for example, a one second edit unit in phase alternating line (PAL) or 1000/1001 seconds edit units in the National Television System Committee (NTSC).

In case a standard compliant decoder does not recognize or receive the information regarding the number of fixed bytes and fixed duration held in the Header Metadata 215 and 315 or in an outbound mechanism, the decoder will interpret the file as a regular file and will need to use the current available methods without the optimizations described in these embodiments.

Phase alternating line is an analog television color encoding system used in broadcast television systems in many countries. Other common analog television systems are NTSC and SECAM. NTSC is the analog television system that is used in most of North America and South America. SECAM, a French acronym, is an analog color television system first used in France. The nominal 30 frames/60 fields per second of NTSC color television is usually multiplied by 1000/1001 to produce slightly reduced rates of 29.97 and 59.94 Hz. This offset gives rise to features such as drop-frame timecode and audio that also has to run at the right rate.

FIG. 4 illustrates an essence container 425 having constant bytes per element edit unit group, CBE Group. The essence container includes picture and padding elements. The picture element is the smallest unit of picture that can be represented or controlled (e.g., a portion of an encoded video frame, a slice of a frame, a full frame or several frames). After the picture element group, the encoder will include a padding or stuffing element so that the edit unit group is a CBE Group.

The constant bytes per element edit unit group is configured for material exchange format operational pattern atom (MXF OP-Atom). The material exchange format OP-Atom is an operational pattern for a file with a tightly defined structure for a single item of essence described by a single essence track. OP-Atom is designed for applications where each essence track is held separately. OP-Atom files are applicable to content authoring steps such as non-linear editing, where programs are created by slicing and dicing different sections of source material. OP-Atom files are output by some digital video cameras. OP-Atoms are ideal for keeping the picture and sound information separate. OP-Atoms also improve the linkage between different assets by using mechanisms in material exchange format structural metadata that enable linking the OP-Atom files together. The documentation standard for the material exchange format OP-Atom is SMPTE ST 390:2011.

FIG. 5 illustrates an essence container 525 which includes an edit unit combined with frame wrapping. The essence container 525 includes data, picture, sound, and padding elements. Sound and data elements typically contain similar amounts of sound and data encoded information to match the same period duration of the video element.

The edit unit Group combined with frame wrapping can be configured for material exchange format OP1A or similar. These operational patterns are preferred for applications where each file represents a complete program or take. OP1A is for a file with a single playable essence comprising a single essence element or interleaved essence elements, that is, the content may consist of multiple, interleaved tracks of picture and sound. OP1A files are nicely self-contained and can work well in applications where each file represents a complete program or take but may be less applicable to content authoring steps such as non-linear editing, where programs are created by slicing and dicing different sections of source material. The documentation standard for the material exchange format OP1A is SMPTE ST 378:2004

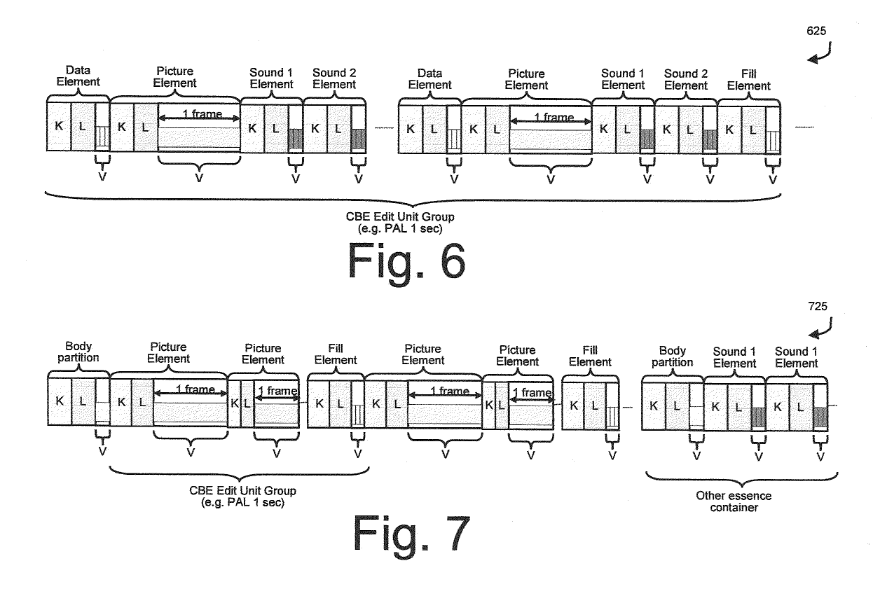

FIG. 6 illustrates an essence container 625 which includes an edit unit Group in multiplexed frame wrapping and is also configured for material exchange format OP1A or similar. The essence container 625 includes data, picture, sound, and fill elements. In this case, the data and sound elements will be placed right before or after the picture element. Several of these edit units plus one fill item will make the CBE Edit Unit Group.

FIG. 7 illustrates an essence container 725 which includes an edit unit Group multiplexed in independent Essence containers. Each picture, data or sound element will be treated independently like in the essence container 425. Each Edit Unit Group is treated per each Essence container type. It will be required to signal the CBE Group byte size and Edit Unit Group Period, T Group, for each Essence container that uses the Edit Unit Group mechanism. It is not required that all Essence containers held in the same file use the Edit Unit Group mechanism herein described.

The essence container 725 is padded with fillers or extra padding (e.g., the material exchange format transport layer) while still demultiplexing these fillers. In the conventional material exchange format decoding process, these fillers would be removed.

The fixed byte size represents the fixed time duration for the encoded and formatted video file 130. The video data can be multiplexed into one file using material exchange format OP1A, stored into independent and separate files using material exchange format OP-Atom or multiplexed using several essence containers using material exchange format OP1B. This Edit Unit Group fixed size and fixed time duration, T Group, must be included in an outbound place of non-material exchange format files, or placed in the material exchange format Header metadata 215 and 315.

For bigger time periods, the method requires less overhead in the filler and less overhead in the size. In other words, the larger synchronization intervals T, the smaller are the overheads. Conversely, the smaller synchronization intervals T, the bigger overhead size. However, the smaller intervals T produce higher seekable points. When T is 1 second, the byte overhead is less than 10% for padding constant bit-rate streams in material exchange format constant bytes per element units according to MPEG specifications, when the encoder uses the maximum video buffering verifier buffer size at the maximum bitrate. When T is 2 seconds, the byte overhead is less than 5%.

Embodiments of the present invention apply to any MPEG encoder that creates a constant or variable bit-rate stream at any bitrate. The encoder generates a stream compliant to the Society of Motion Picture and Television Engineers material exchange format documents.

Embodiments of the present invention provide benefits while decoding. When opening a file that is continually being written, the decoder is fast to open a file with minor seek access to any point in the growing file; fast to determine the available file duration; and has little to no random access reads while seeking.

In one embodiment, for decoding a video frame within constant bytes per element unit Group (CBE Group) unit requires for the decoder to use the following three step algorithm after it has obtained the CBEGroupSize and TGroup. First, identify the byte offset of the essence by CBEGroupUnitByteOffset=floor (frameToDisplay/framesPerCBEGroup)*CBEGroupSize where framesPerCBEGroup=TGroup x video frame rate. This equation assumes that a stream starts at 0 frames, precharge frame can be 0 or higher, and frameToDisplay is higher than the precharge frame.

Second, the decoder seeks to CBEGroupUnitByteOffset navigate in the KLV structure. This will allow the decoder to seek to CBEGroupFramePosition, calculated as: CBEGroupFramePosition=CBEGroupUnitByteOffset/CBEGroupSize, or as CBEGroupFramePosition=floor (frameToDisplay/framesPerCBEGroup). Third, the CBEGroupFramePosition frames will be sent to decoder as the pre-load until the correct frameToDisplay is reached.

In some occasions it may be possible to simplify the above method in case it is not required by the decoder to understand the CBE Group or TGroup. In this case, the Essence Container Edit Unit stored in the MXF Edit Unit rate will be equal to the Edit Unit rate Group or 1/T Group and the edit unit size will be equal to the CBE Group Size. Using this simplification edit rate will be equal to Edit Unit Group rate.

The system 100 includes other features as well. The recorder 115 can record in multi resolution with simultaneous generation of hi-res and proxy versions. The recorded file can be stored in multiple destinations with flexibility of generating material exchange format, Avid and QuickTime files simultaneously, for complex workflows. The recorder 115 can have a metadata annotation engine to ease the proper identification of material, saving the user 170 time and money. The recorder 115 can have scalability and reliability in compact units with unlimited expansion and optional fallback storage. The system 100 allows remote access and control using a web-based graphical user interface (GUI) or a SOAP control interface 175, allowing the user 170 to control the system 100 anytime and anywhere.

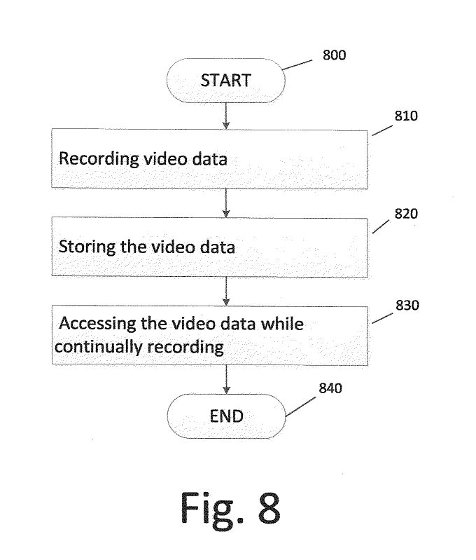

FIG. 8 illustrates a process of accessing video data while recording according to an embodiment of the invention. The process starts at step 800. At step 810, the video camera 105 records and encodes the video data signal 110. The video data signal 110 includes audio and video. Then, at step 820, the storage 135 stores the encoded video data 130. The user interface 165 accesses the formatted and encoded video files 145 while continually recording at step 830. The video data or file can be stored, accessed, previewed, and edited on the fly, that is, while the video is simultaneously recording before it has finished. The process may be repeated recursively a number of times and ends at step 840.

It is to be recognized that depending on the embodiment, certain acts or events of any of the methods described herein can be performed in a different sequence, may be added, merged, or left out altogether (for example, not all described acts or events are necessary for the practice of the method). Moreover, in certain embodiments, acts or events may be performed concurrently, for example, through multi-threaded processing, interrupt processing, or multiple processors, rather than sequentially.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

What is claimed is:

1. A system comprising:
a video camera configured to form a video data signal;
a recorder coupled to the video camera, the recorder configured to record the video data signal;
an encoder coupled to the recorder, the encoder configured to encode and format the video data signal into a constant byte per edit unit group having a video file that is formatted, encoded, and has a deterministic seek capability;
a storage coupled to the recorder, the storage configured to store the video file; and
a user interface coupled to a computer, the user interface configured to access the video file while continually recording.

2. The system of claim 1, wherein the user interface comprises a player, wherein the player is configured to preview the video file while the video file is being recorded.

3. The system of claim 1, wherein the user interface comprises an editor, wherein the editor is configured to edit the video file while continually recording.

4. The system of claim 1, further comprising a processor coupled to the recorder, wherein the processor is configured to receive the video data signal and send the video file to the storage.

5. The system of claim 1, further comprising continually recording using an enhanced decoder or a regular decoder.

6. The system of claim 1, wherein the recorder comprises a controller configured to control a schedule, recording, and metadata via a RS422, HTTP or SOAP control interface.

7. The system of claim 1, wherein the encoder comprises a generic encoder.

8. The system of claim 1, further comprising a decoder coupled to the computer.

9. A method comprising:
forming a video data signal using a video camera;
recording the video data signal;
encoding and formatting the video data signal into a constant byte per edit unit group having a video file having a video file that is formatted, encoded, and has a deterministic seek capability;
storing the video file in a storage; and
accessing the video file while continually recording.

10. The method of claim 9, further comprising previewing the video file while continually recording.

11. The method of claim 9, further comprising editing the video file while continually recording.

12. The method of claim 9, further comprising receiving the video data signal using a processor and sending the video file to the storage.

13. The method of claim 9, further comprising continually recording using an enhanced decoder or regular decoder.

14. An apparatus comprising:
an input configured to receive a video data signal;
a recorder coupled to the input, the recorder configured to record the video data signal;
an encoder coupled to the recorder, the encoder configured to encode and format the video data signal into a constant byte per edit unit group having a video file that has a deterministic seek capability; and
an output configured to send the video file to a user interface coupled, the user interface configured to access the video file while continually recording.

15. The apparatus of claim 14, wherein the user interface comprises a player, wherein the player is configured to preview the video file while the video file is being recorded.

16. The apparatus of claim 14, wherein the user interface comprises an editor, wherein the editor is configured to edit the video file while continually recording.

17. The apparatus of claim 14, further comprising a processor coupled to the recorder, wherein the processor is configured to receive the video data signal and send the video file to the storage.

18. The apparatus of claim 14, further comprising continually recording using an enhanced decoder or a regular decoder.

19. The apparatus of claim 14, wherein the recorder comprises a controller configured to control a schedule, recording, and metadata via a RS422, HTTP or SOAP control interface.

20. The apparatus of claim 14, wherein the encoder comprises a generic encoder.
